(19) United States
(12) Patent Application Publication
(10) Pub. No.: US 2014/0144982 A1
(43) Pub. Date: May 29, 2014

(54) NEAR FIELD COMMUNICATION DEVICE

(71) Applicant: Lawrence E. ANDERSON, Arlington, VA (US)

(72) Inventor: Lawrence E. ANDERSON, Arlington, VA (US)

(21) Appl. No.: 13/688,174

(22) Filed: Nov. 28, 2012

(51) Int. Cl. G06Q 20/20

(52) U.S. Cl. CPC G06Q 20/201
USPC 235/380; 235/375

(57) ABSTRACT

A first device comprises an NFC port adapted to communicate with a sales terminal; at least one processor; at least one input for inputting one of bar codes, Universal product codes, pricing information, payment card information; whereby pricing information is compared with sales terminal pricing via near field communication protocol to determine proper entry of sales information. A second hand held device comprises at least one processor; at least one memory; a display operatively associated with the at least one processor; a near field communication port adapted to communicate with a sales terminal for transmitting the listing of items being purchased and the associated selling price; at least one input for inputting pricing information from coupons, store advertisements, and internet sales information into the memory; the at least one processor operating to compare each item on the listing of items and associated price with the previously inputted information.

### BACKGROUND

Near Field communications is a blossoming area in the field of business transaction devices and systems. According to Wikipedia, near field communication (NFC) is a set of standards for smartphones and similar devices to establish radio communication with each other by touching them together or bringing them into close proximity, usually no more than a few centimeters. Present and anticipated applications include contactless transactions, data exchange, and simplified setup of more complex communications such as Wi-Fi. Communication is also possible between an NFC device and an unpowered NFC chip, called a “tag”.

Wikipedia further states that NFC standards cover communications protocols and data exchange formats, and are based on existing radio-frequency identification (RFID) standards including ISO/IEC 14443 and FeliCa. The standards include ISO/IEC 1809 and those defined by the NFC Forum, which was founded in 2004 by Nokia, Philips and Sony, and now has more than 160 members. The Forum also promotes NFC and certifies device compliance.

For example, a ticket stamping machine of the Austrian Federal Railways that can be used to purchase mobile tickets (“Handy-Ticket”).

According to Wikipedia, smartphones equipped with NFC can be paired with NFC tags or stickers which can be programmed by NFC apps to automate tasks. This can allow for a change of phone settings, a text to be created and sent, an app to be launched, or any number of commands to be executed, limited only by the NFC app and other apps on the smartphone.

### SUMMARY OF PRESENT INVENTION

A preferred embodiment of the present invention comprises a system for automating discount mechanisms, such as coupons and memberships codes, with payment systems, such as credit cards, in conjunction with an optional fingerprint reading security system. Optionally, a phone system may be included.

A preferred embodiment comprises a hand held device for capturing and storing pricing information comprising a near field communication port adapted to communicate with a sales terminal; at least one processor; at least one input for inputting one of bar codes, Universal product codes, pricing information, credit card and debit card information; whereby pricing information is compared with sales terminal pricing information via near field communication protocol to determine proper entry of sales information. Optionally, the at least one processor operates to corroborate price reductions at a store by entering the product code and sales price and automatically checking the tallied prices at the check out to determine whether or not the sales price has been charged. Optionally, the device comprises a display and wherein bar codes from store savings cards can be inputted through the at least one input and displayed on the display. Optionally, the device comprises a finger or thumb print reader activation for security purposes. Optionally, the device may include a scanner for universal product codes, a scanner for the inputting of coupons, a scanner operatively connected to an optical character reader for inputting pricing information, a keyboard for manual inputting of pricing information, and a camera for inputting of pricing information from advertisements. Optionally the device may scan coupons and the at least one processor may organize the coupons by subject matter and delete the coupons upon expiration of the coupon. Optionally, the information inputted from a sales terminal includes a listing of items to be purchased identified by universal product code, a cost associated with the universal pricing code that is to be charged by the store, and wherein the at least one processor operates to compare the listed universal product codes with previously entered pricing information from advertizing sources and coupons, and wherein the at least one processor provides an error notice when the comparison of pricing information from the sales terminal and previously entered pricing information is not the same. Optionally, the device may store credit card information to enable the user to make payment to the sales terminal using near field communications. The device may further include a USB port and have the ability to connect wirelessly to the Internet.

Another embodiment comprises a hand held device for storing pricing information comprising: at least one processor; at least one memory operatively connected to the at least one processor; a display operatively associated with the at least one processor; a near field communication port adapted to communicate with a sales terminal for transmitting the listing of items being purchased and the associated selling price; at least one input for inputting pricing information from coupons, store advertisements, and internet sales information into the memory; the at least one processor operating to compare each item on the listing of items and associated selling price with the previously inputted sales information in order to detect errors in the prices being charged at the sales terminal. Optionally, if the information from a coupon matches an item in the listing of items, the display displays the coupon information. Optionally, the listing of items being purchased includes the taxes and total being charged and is entered into the memory for storage therein as a separate file to enable future recall. Optionally, payment is transmitted to the sales terminal from the memory via the near field communication port. Optionally, the device comprises a scanner and the previously stored sales information can be recalled by the operator by scanning a universal product code.

### BRIEF DESCRIPTION OF THE DRAWINGS

These and/or other aspects and advantages of the invention will become apparent and more readily appreciated from the following description of the embodiments, taken in conjunction with the accompanying drawings of which: The drawings of this invention are illustrative and diagrammatic in nature in order to present the principles of the invention. They are being provided as examples without limiting the invention to the specific configuration or dimensions shown.

FIG. 1 is a diagrammatic illustration of a preferred embodiment personal assistant device in which barcodes are inputted and displayed and/or transmitted using near field communications.

FIG. 2 is a diagrammatic illustration of a preferred embodiment personal assistant device (including smart phone or tablet) comprising options such as a scanner for price (OCR reader) 204, keyboard (virtual or real) 204, scanner for Universal product code, and/or camera for pictures of advertisement or displays showing, inter alia, discounted prices.

FIG. 3 is a schematic illustration in flow chart style of a preferred embodiment comprising a near field communicator, such as a personal assistant device, smart phone and/r tablet, in conjunction with a similar flow chart for a terminal (such as a cashier's terminal).

FIG. 4 is an illustration showing a cashier's terminal sales tally 501, a preferred embodiment personal assistant device's (including smart phone, tablet) inputted data 503 and a comparison 505 which shows (such as by highlighting errors 506.

FIG. 5 is an illustration comprising a flow chart for a preferred embodiment personal assistant device (including a smart phone or tablet) for inputting pricing information and comparing the pricing information to terminal inputted pricing information via near field communication protocol.

FIG. 6 is a diagrammatic illustration comprising inputs into a preferred embodiment personal assistant device, such as a smart phone or tablet, which may be read, scanned or transmitted, stored into and optionally organized.

FIG. 7 is a schematic illustration of a preferred embodiment personal assistant device (such as a smart phone or tablet) showing coupons inputted via a scanner.

FIG. 8 is a schematic illustration of a preferred embodiment personal assistant device (such as a smart phone or tablet) showing a display 901.

### DETAILED DESCRIPTION OF PREFERRED EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

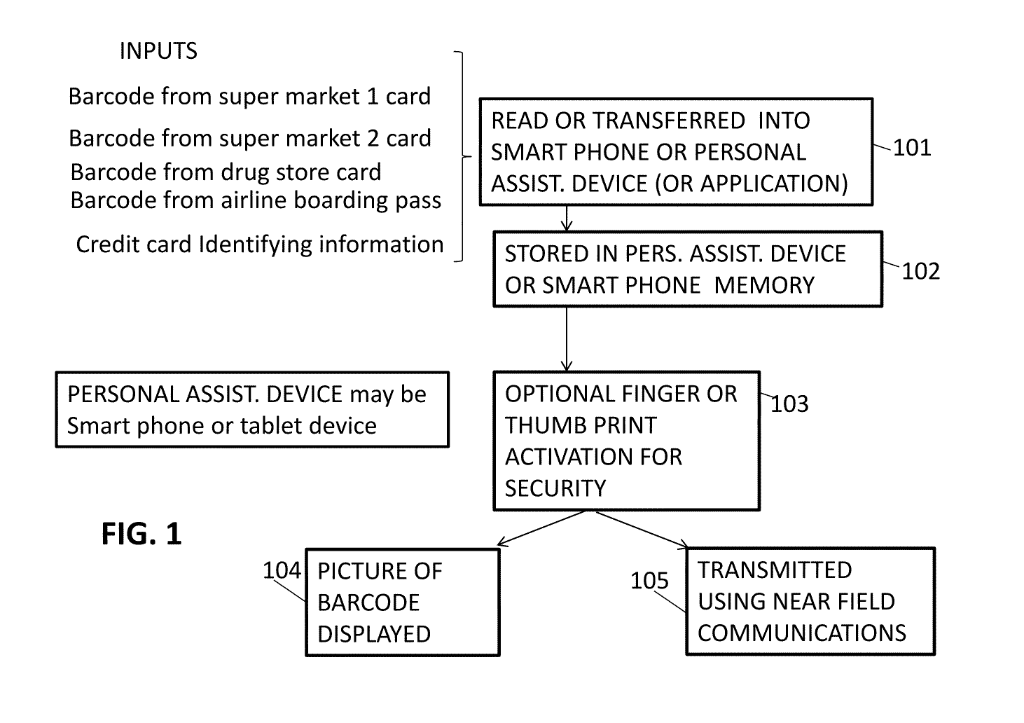

FIG. 1 is a diagrammatic illustration of a preferred embodiment personal assistant device in which barcodes are inputted (box 101) and displayed (box 104) and/or transmitted using near field communications (box 105). Examples of inputs include super market savings cards, drug store savings cards, bar codes from airline boarding passes and credit card information. Once these items are inputted into the personal assistant device, such as a smart phone or tablet, they may be stored and later produced at the store or airline boarding gate. The preferred embodiment personal assistant may display (104) the inputted information and/or transmit it via near field communications (105). Optionally, the personal assistant device may be secured though a finger or thumb print verification input 103.

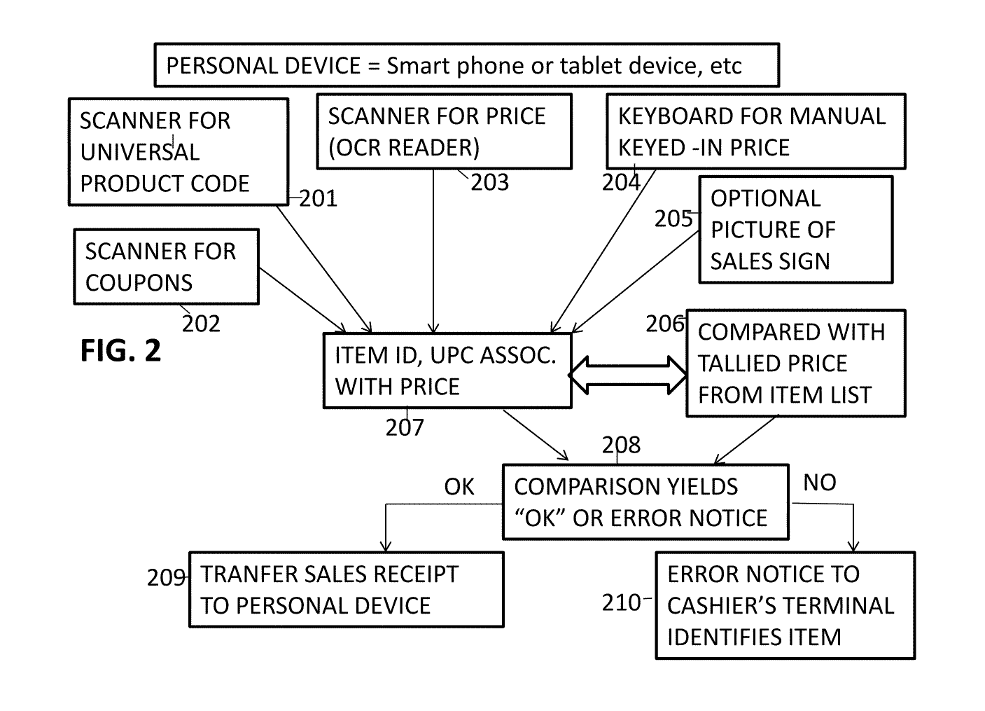

FIG. 2 is a diagrammatic illustration of a preferred embodiment personal assistant device (including smart phone or tablet) comprising options such as a scanner for UPC codes (box 201), scanner for coupons (box 202), scanner for price (OCR reader) (box 203), keyboard (virtual or real) 204, keyboard for manual input of prices (box 204), and/or camera for pictures of advertisement or displays showing, inter alia, discounted prices (box 205). The personal assistant device captures relevant data comprising for example, the item identification and/or UPC codes associated with price (box 207). In box 206, the pricing information inputted into the personal assistant is compared with the tallied price from the cashier's item list (or receipt information). As depicted in box 208, pricing information inputted into the personal assistant device (such as through discount signs, coupons, advertisements, etc.) is compared to the store listing of items (receipt data) in effort to detect an improper charge. An analogy may be made to the process of requesting a price check at a store register or cashier's terminal. Instead of requiring the clerk to stop the processing of items and check on a price, the personal assistant compares the pricing information and determines a pricing error.

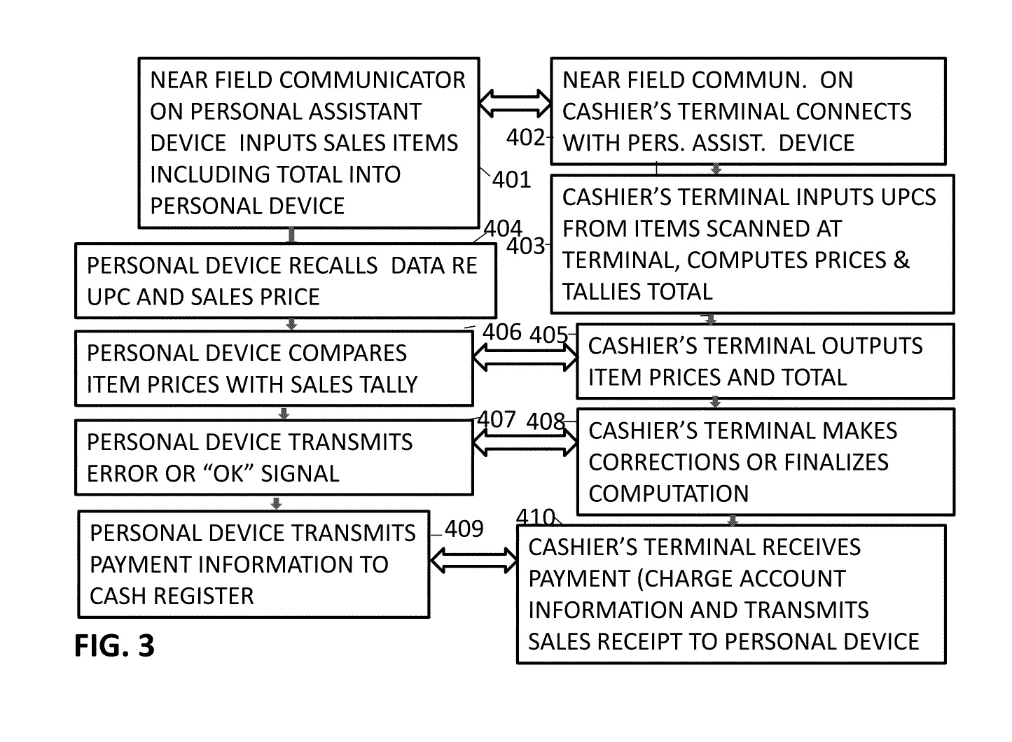

FIG. 3 is a schematic illustration in flow chart style of a preferred embodiment comprising a near field communicator, such as a personal assistant device, smart phone and/r tablet, in conjunction with a similar flow chart for a terminal (such as a cashier's terminal). The procedures that may be performed by a smart phone or personal digital assistant or tablet are shown to the left of FIG. 3. The procedures that may be performed by a cashier's terminal are shown to the right. Near field communications and/or direct input may be used to transfer information from the preferred embodiment personal assistant device to the cashier's terminal. As shown in box 401, the personal assistant has items such as coupons (including discounted price, UPC, expiration date, and quantity information) and advertisements inputted. In box 402 the near field communications transmitter/receiver on the cashier's terminal or the like communicates with the personal assistant device (smart phone or tablet). In box 403, the items being purchased at a store are tallied by scanning the bar codes in a customary manner. The terminal (which may comprise a processor or computer) computes the prices and tallies the total for the production of a total, which may be produced in the customary receipt fashion or transmitted to the personal device via near field communications in box 405, thereby eliminating the need for a receipt. In box 404, the personal assistant device recalls data regarding price, UPC codes. In box 406, the personal assistant device compares the item prices with the sales tally produced at the sales terminal. In box 407, the personal assistant, following comparison of the prices and bar codes, transmits an “OK” or an error signal signifying the checking of the stores tally for the correct pricing information (which was previously inputted into the personal assistant device (smart phone or tablet). In box 408, the cashier's terminal makes corrections or finalizes the computation. In box 409, the personal assistant device transmits payment information (such as credit or debit card information) to the sales terminal. In box 410, the sales terminal received payment information and transmits sales receipt information to the personal assistant device.

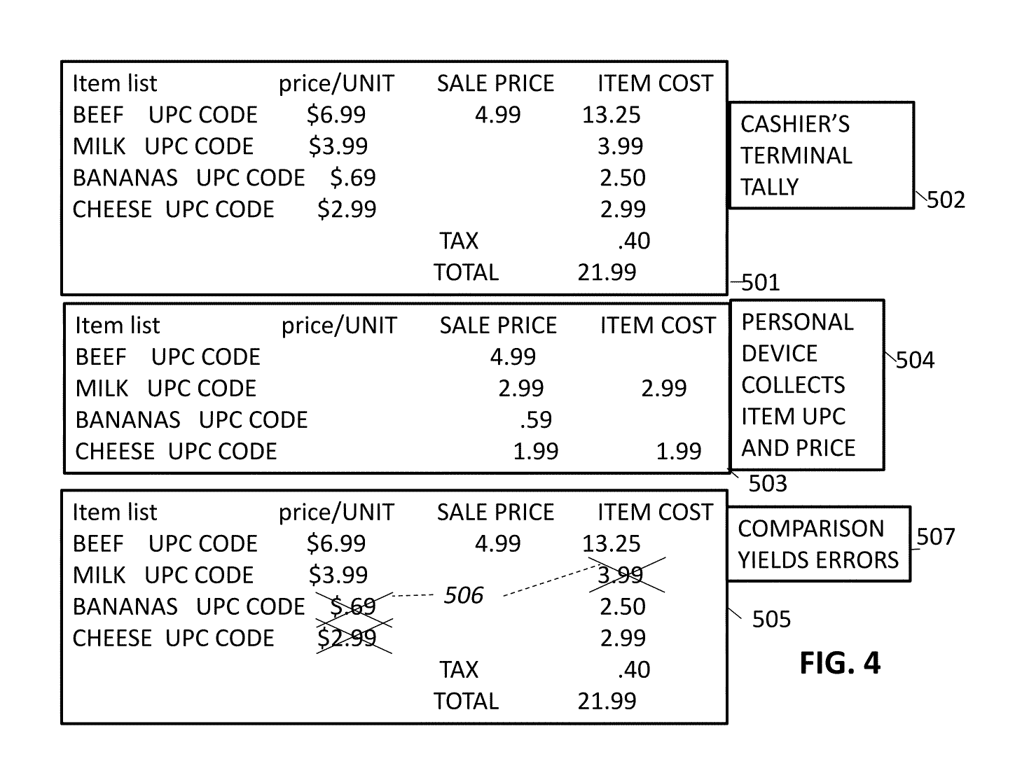

FIG. 4 is an illustration showing a cashier's terminal sales tally 501, a preferred embodiment personal assistant device's (including smart phone, tablet) inputted data 503 and a comparison 505 which shows (such as by highlighting errors 506). The comparison of data inputted into the personal assistant device may yield errors 506 which may appear by a cross-out representation, highlighting or flashing or the like. Alternately, a message advising that an error has occurred and a description of the error may appear on the display of the personal assistant. Alternately, the display or notification of the error may appear on the sales terminal.

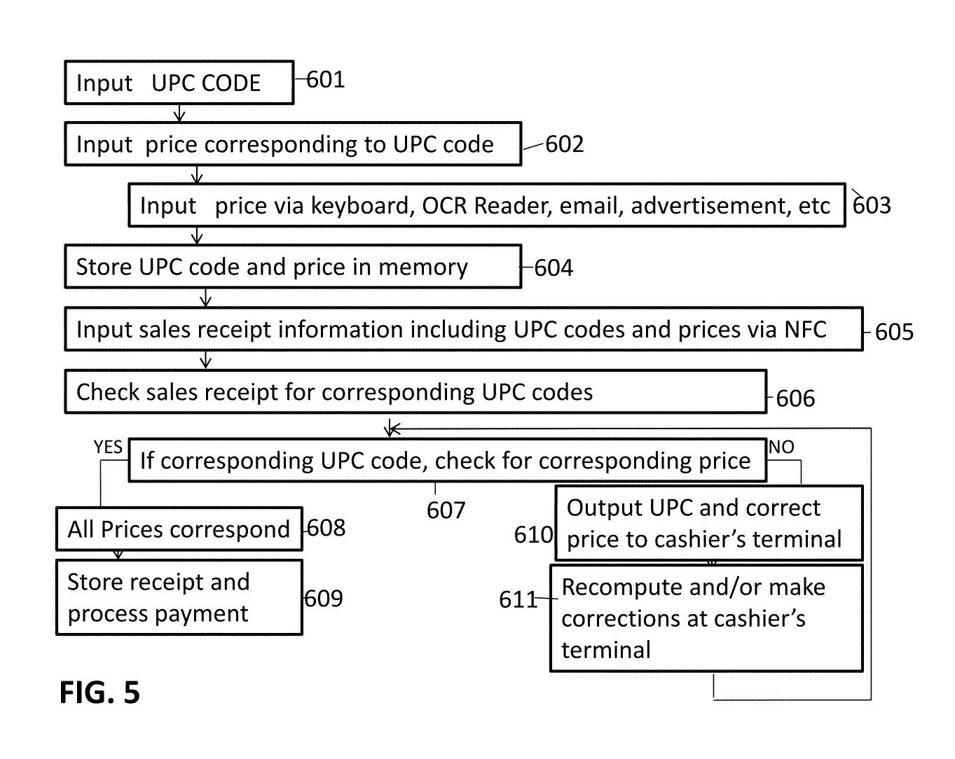

FIG. 5 is an illustration comprising a flow chart for a preferred embodiment personal assistant device (including a smart phone or tablet) for inputting pricing information and comparing the pricing information to terminal inputted pricing information via near field communication protocol. In box 601, a UPC code is inputted into the personal assistant device. Box 602 represents the inputting of pricing data which may be done simultaneously or contemporaneously with the UPC input. Optionally, as represented by box 603, the pricing information may be inputted via key board, OCR reader, email, advertisement, etc. Box 604 represents the storage of the UPC codes and prices in memory of the personal digital assistant. Box 605 represents the inputting of sales receipt information including UPC codes, prices and/or item description via near field communications from the sales terminal. Box 606 represents the checking of the sales tally of the purchased items with the information stored in the personal assistant device via UPC codes and/or item identification and pricing information. Box 607 represents the checking of the pricing information which may be performed by a processor in the sales terminal or a processor in the personal assistant device (or both the terminal and personal assistant device. A decision is made; if the prices are correct (box 608) the store receives and processes payment from the customer via the personal assistant device (or manually by cash or credit card). If an error is determined to have been made, the decision tree enters box 610. Pricing information is recomputed and/or corrections are made as represented by box 611.

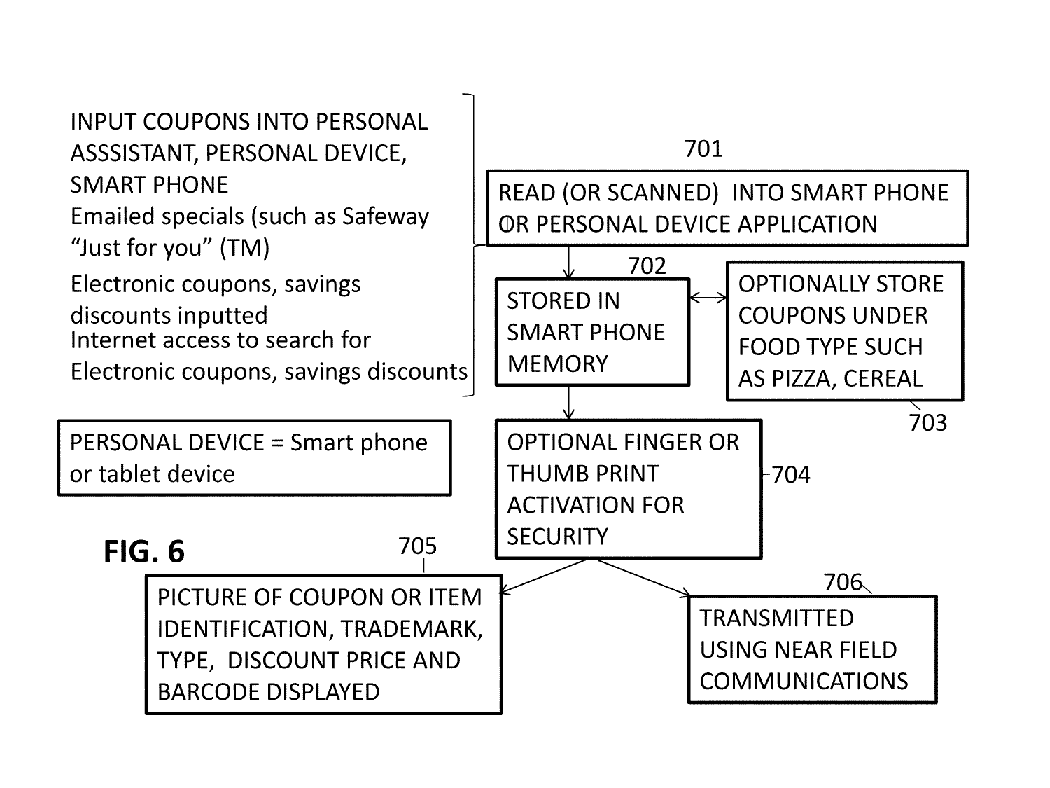

FIG. 6 is a diagrammatic illustration of a preferred embodiment personal assistant device comprising inputs into a preferred embodiment personal assistant device, such as a smart phone or tablet, which may be read, scanned or transmitted, stored into and optionally organized. Barcodes, coupons, email specials, electronic coupons are inputted (box 701) and displayed (box 705) and/or transmitted (box using near field communications (box 706). Examples of inputs include super market savings cards, drug store savings cards, bar codes from airline boarding passes and credit card information. Once these items are inputted into the personal assistant device, such as a smart phone or tablet, they may be stored and later produced at the store or airline boarding gate. The preferred embodiment personal assistant may display (705) the inputted information and/or transmit it via near field communications (706). Optionally, the personal assistant device may be secured though a finger or thumb print verification input 704.

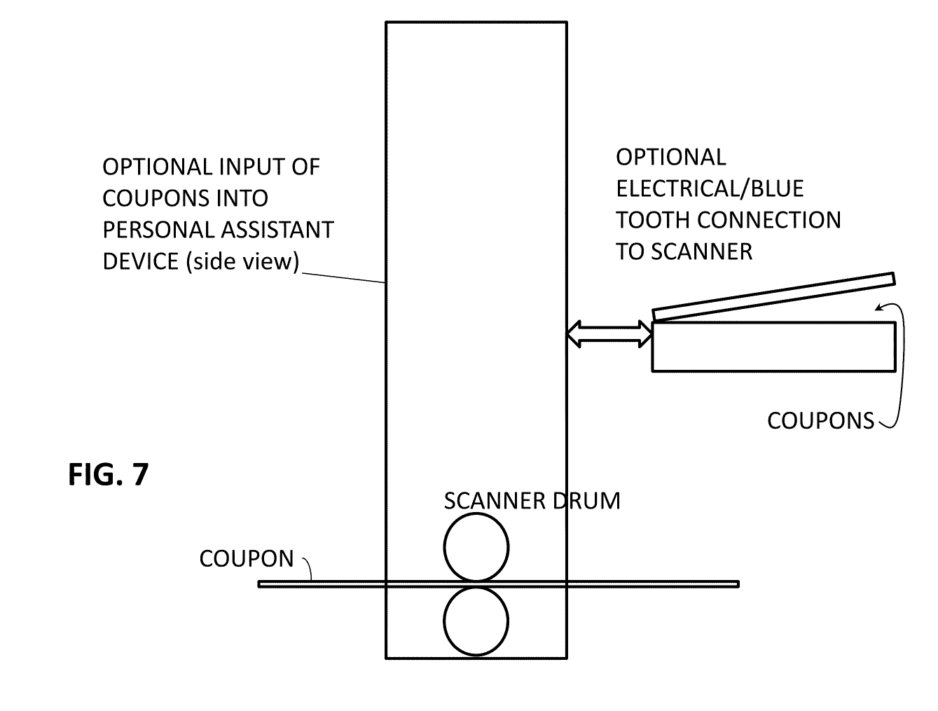

FIG. 7 is a schematic illustration of a preferred embodiment personal assistant device (such as a smart phone or tablet) showing coupons inputted via a scanner. The scanner may be part of the personal assistant device or connected to the personal assistant device via cable or blue tooth transmission

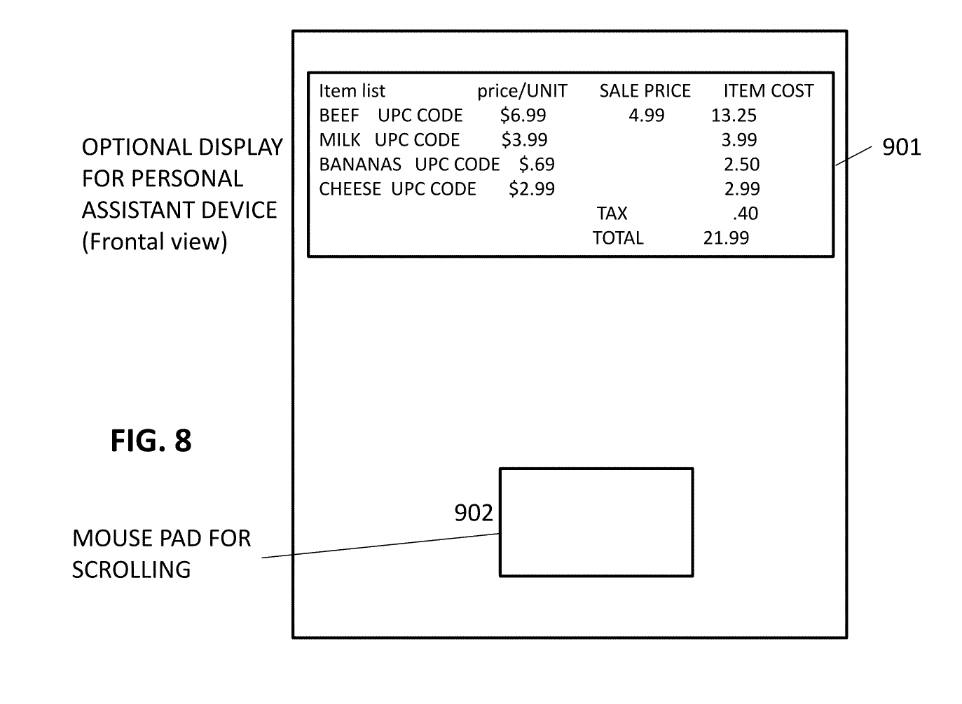

FIG. 8 is a schematic illustration of a preferred embodiment personal assistant device (such as a smart phone or tablet) showing a display 901. The scrolling of the display 901 may be controlled by a mouse pad 902.

Supermarkets commonly offer value savings or discounts which do not materialize at the checkout register. On realizing the discount error, one may request a price check; but the same is met by angry scowls from those behind in the supermarket line.

One may enter the barcode with a barcode scanner, enter the discounted price, and then, with the capability of near field communications, automatically match the entered price with the price “rung” up at the register. Optionally, the device may take a picture of the offered/discounted price which then may be displayed to the clerk for verifying the accuracy. Conceivably, the device could pay for itself by through insuring the charging of the discounted price at the register, without requiring price checks.

As used herein term personal assistant device includes a smart phone, tablet, personal assistant digital device, portable hand-held device, or the like.

As used herein the terminology “processor” or “controller” as used herein may be a microprocessor, computer, programmable controller, programmable chip, multiprocessor, personal computer, CPU, coprocessor, central processor, or the like.

As used herein the terminology “external” means external to the personal assistant device.

As used herein, the terminology “port” means “I/O,” input and output which may be for example a receiver and/or transmitter.

As used herein, a finger or thumb print reader is a device which detects whether or not the finger or thumb print of a user has been applied to a sensor in order to determine the identity of the user.

Embodiments of the present invention are described herein are schematic illustrations of idealized embodiments of the present invention. As such, variations from the shapes of the illustrations as a result, for example, of manufacturing techniques and/or tolerances, are to be expected. The embodiments of the present invention should not be construed as limited to the particular shapes of displays illustrated herein but are to include deviations in shapes that result, for example, from manufacturing. The regions (or display areas) illustrated in the figures are schematic in nature and their shapes are not intended to illustrate the precise shape of a region and are not intended to limit the scope of the present invention.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

1. A hand held device for capturing and storing pricing information comprising:
a near field communication port adapted to communicate with a sales terminal;
at least one processor;
at least one interface for inputting bar codes, universal product codes, pricing information, credit card and debit card information;
whereby pricing information is compared with sales terminal pricing information via near field communication protocol to determine proper entry of sales information.

2. The device of claim 1 wherein the at least one processor operates to corroborate price reductions at a store by entering a product code and sales price and automatically checking a tallied prices at the check out to determine whether or not a correct sales price has been charged.

3. The device of claim 2 wherein the device comprises a cell phone and a display and wherein bar codes from store savings cards can be inputted through the at least one input and displayed on the display; and wherein the device further comprises a memory for storage of credit card information to enable the user to make payment to the sales terminal using the near field communications port, and wherein the memory operates to store sales information and receipt information using the near field communications port for later usage outside of the store.

4. The device of claim 3 further comprising finger or thumb print reader activation for security purposes.

5. The device of claim 4 wherein the at least one interface comprises a scanner for universal product codes, a scanner for inputting coupons, a scanner operatively connected to an optical character reader for inputting pricing information, a keyboard for manual inputting of pricing information, and a camera for inputting of pricing information from advertisements.

6. The device of claim 1 wherein the at least one interface operates to scan coupons and the at least one processor operates to organize coupons by subject matter and to automatically delete a coupon upon expiration of the coupon.

7. The device of claim 1 wherein information is inputted from a sales terminal including a listing of items to be purchased identified by universal product code, a cost associated with a universal pricing code that is to be charged by a store, and wherein the at least one processor operates to compare listed universal product codes with previously entered pricing information from advertizing sources and coupons, and wherein the at least one processor provides an error notice when the comparison of pricing information from the sales terminal and previously entered pricing information is not the same and wherein payment is transmitted to the sales terminal from the memory via the near field communication port when information from the sales terminal and previously entered pricing information is the same.

8. The device of claim 7 further including credit card information to enable a user to make payment to the sales terminal using near field communications.

9. The device of claim 8 further comprising a memory wherein prior to the time of payment a receipt is inputted electronically through the near field communication port into the memory such that the memory stores receipt information including item prices, universal product codes, taxes, and total to be paid.

10. The device of claim 8 further including an USB port for communication with a laptop or desktop computer wherein pricing and payment information is transferable to the laptop or desktop computer.

11. The device of claim 10 wherein the at least one processor operates to input a listing of sales items including the total into memory, the at least one processor operates to compare each listing item with previously entered pricing information and if a match occurs, the pricing information is checked to see that the sales terminal information is correct and if not, an error is signaled.

12. The device of claim 11 further comprising a display and wherein previously entered pricing information includes information from coupons stored in memory, and wherein if an item match occurs, a corresponding coupon is displayed.

13. The device of claim 11 wherein if the sales terminal information is deemed correct, credit card information is transmitted through the near field communication port to the sales terminal and wherein an error is signaled when the sales terminal information is deemed incorrect.

14. The device of claim 13 further comprising a display and wherein previously entered pricing information includes pricing information entered by the user concerning items on sale, and wherein if an item match occurs between the previously entered pricing information and items being processed at the sales terminal, the previously entered pricing information will appear on the display adjacent to the item being purchased and if a match does not occur the previously entered pricing information will not appear.

15. The device of claim 11 wherein the previously entered information includes pricing information entered by the user concerning items on sale, and wherein if an item match occurs between the previously entered pricing information and items being processed at the sales terminal, the previously entered pricing information will be transferred to the sales terminal via the near field communication port and if a match does not occur the previously entered pricing information will not be transferred.

16. A hand held device for storing pricing information comprising:
at least one processor;
at least one memory operatively connected to the at least one processor, the at least one memory operating to store credit card information of the user;
a display operatively associated with the at least one processor;
a near field communication port adapted to communicate with a sales terminal for transmitting a listing of items being purchased and an associated selling price;
at least one interface for inputting pricing information from coupons, store advertisements, and internet sales information into the memory;
the at least one processor operating to compare each item on the listing of items and associated selling price with the previously inputted pricing information in order to detect errors in prices being charged at the sales terminal; the at least one processor operating to signal an error when the comparison of pricing information from a sales terminal and previously entered pricing information is not the same; the at least one processor operating to transfer credit card information to a sales terminal from the memory via the near field communication port when information from the sales terminal and previously inputted pricing information is the same; and
the at least one processor operating to transfer a receipt from the sales terminal to the memory.

17. The device of claim 16 wherein if the coupon information from a coupon matches an item in the listing of items, the display displays the coupon information.

18. The device of claim 16 wherein the device comprises a cell phone integral therewith and the memory is contained therein and wherein listing of items being purchased includes taxes and total being charged and is entered into the memory for storage therein as a separate file to enable future recall.

19. The device of claim 16 further comprising a cell phone integral therewith and wherein payment is transmitted to the sales terminal from the memory via the near field communication port.

20. The device of claim 16 further comprising a scanner and wherein previously stored sales information can be recalled by an operator by scanning a universal product code.
